(19) United States
(12) Patent Application Publication
(10) Pub. No.: US 2009/0219427 A1
(43) Pub. Date: Sep. 3, 2009

(54) IMAGE SENSOR AND IMAGE DATA PROCESSING METHOD

(75) Inventors: Hoon Kim, Seoul (KR); Kwang Sue Park, Gyeonggi-do (KR)

Correspondence Address: THE RAFFERTY PATENT LAW FIRM, 1952 Gallows Road, Suite 200, Vienna, VA, 22182-3823, US

(73) Assignee: PLANET82 INC., Seoul (KR)

(21) Appl. No.: 12/089,514

(22) PCT Filed: Apr. 12, 2006
(86) PCT No.: PCT/KR06/01330

§ 371 Date: Oct. 3, 2008

(30) Foreign Application Priority Data
Nov. 7, 2005 (KR) 10-2005-0106193

(51) Int. Cl. H04N 5/335

(52) U.S. Cl. 348/308; 348/E05.091

(57) ABSTRACT

An image sensor and a method for processing image data, can reduce a large proportion of data signals corresponding to high illumination and a small proportion of data signals corresponding to low illumination in order to generate an image just like the original, by adjusting the reset sampling period pertaining to the data signals outputted from a unit pixel. The image sensor includes a first switch which is operated by a reset sampling signal for sampling reset voltage when a voltage drop in an image data signal occurs, in which the image data signal is applied from a picture element part, a first capacitor for storing the reset voltage applied from the first switch, a second switch which is operated by a data sampling signal for sampling data voltage after completion of the voltage drop in the image data signal, a second capacitor for storing the data voltage from the second switch, and an image data processing circuit equipped with a comparator for comparing the reset voltage with the data voltage.

### TECHNICAL FIELD

The present invention relates to an image sensor and a method for processing image data thereof, more particularly, to an image sensor and a method for processing image data thereof which can reduce a large amount of data signals regarding high illumination and small amount of data signals regarding low illumination in order to embody an image just like the real image, by adjusting the reset sampling section related to the data signals outputted from a unit pixel, i.e. a picture element part.

### BACKGROUND ART

An image sensor is a device which captures images by utilizing the characteristics of a semiconductor, which reacts on external energy such as light energy. Light being generated from an object present in the nature has a characteristic inherent value in properties such as wavelength. A pixel of an image sensor detects the light generated from each object and converts it into a certain electric value. That means, the pixel of an image sensor responds to the light energy generated from an object, and then generates an electric value corresponding to the wavelength of the light received.

Among those, CCD (Charge Coupled Device) is a device in which MOS capacitors are disposed very near to each other, and an electric charge carrier is stored in the capacitor and transferred. While CMOS image sensor is a device which has a pixel array formed by utilizing CMOS integrated circuit fabrication technique and employs a switching mode for detecting output of the pixel array one after another. CMOS image sensors have an important advantage of lower power consumption, thereby being very usefully applied to a personal mobile system such as a mobile phone.

FIG. 1 represents a conventional 3-transistor CMOS active pixel, which illustrates the cross-section of a photodiode comprising circuits for peripheral components. FIG. 2 is an equivalent circuit diagram of the conventional 3-transistor CMOS active pixel represented in FIG. 1. In conventional 3-transistor CMOS active pixels, an N+type impurity region (11) and an N+type floating diffusion region (13) which constitute a junction of a photodiode at one side, contact to each other. Thus, the capacitance component of a photodiode is substantially the sum of the capacitor components formed by the N+type impurity region (11) and the N+type floating diffusion region (13). Accordingly, an image sensor where a conventional 3-transistor CMOS active pixel is applied has a problem of low sensitivity. For making up such problem of a 3-transistor CMOS active pixel, 4-transistor CMOS active pixel has been suggested.

FIG. 3 represents a conventional 4-transistor CMOS active pixel, which illustrates the cross-section of a photodiode comprising circuits for peripheral components. FIG. 4 is an equivalent circuit diagram of the conventional 4-transistor CMOS active pixel represented in FIG. 3. In conventional 4-transistor CMOS active pixels, a transfer transistor (25) which is controlled by a transfer control signal (Tx) is used for removing noises generated from a 3-transistor CMOS active pixel. The N+type impurity region (21) and the N+type floating diffusion region (23) which constitute a junction of a photodiode on one side are separated from each other. By doing so, the sensitivity of an image sensor and the quality of the image can be improved in conventional 4-transistor CMOS active pixels. However, the 4-transistor CMOS active pixel also has a problem of having a reduced light receiving area, owing to the addition of a transfer transistor (25).

In summary, a conventional 3-transistor CMOS active pixel has a problem of low sensitivity, and a conventional 4-transistor CMOS active pixel also has a problem of a reduced light receiving area.

FIG. 5 represents a circuit diagram connected to the picture element part (30) comprised of a combination of unit pixels represented in FIGS. 1 and 3. The picture element part (30) used herein refers to one column comprised of unit pixels. The picture element part (30) is provided as many as the number of the columns, and the number of the unit pixels in the picture element is provided as many as the number of the rows. Those generally used expressions ‘640×480 VGA’, ‘1024×768 XGA’ and ‘1280×1024 SXGA’, respectively, refer to the image resolution of ‘640 columns×480 rows ‘1024 columns×768 rows’ and ‘1280 columns×1024 rows’. Meanwhile, each number of columns and rows practically used in the processes is more than the numbers above represented. FIG. 6 represents the signals applied to the unit pixels of FIGS. 1 and 3.

The circuit and the signal processing illustrated in FIGS. 5 and 6 are as follows. When a select signal is applied to a row consisting of pluralities of unit pixels, a captured image data signal during the row enable section (R_en) in the pluralities of unit pixels is applied from the common junction (31) of a column to CDS (correlated double sampling) (36). Image data signals include data signals corresponding to various levels of illumination depending on the surrounding environment, from a high illumination signal which is the data signal of bright light to a low illumination signal which is the data signal of dimmed light.

These data signals according to various levels of illumination drop the reference voltage applied to a circuit comprising CDS (36) according to each level. It means that the low illumination data signal drops the reference voltage relatively little, but the high illumination data signal drops the reference voltage relatively large. FIG. 7 represents the voltage drop of a data signal according to the illumination level. Three levels are disclosed in FIG. 7, for the sake of convenience; however data signals at more various levels may be present in practical.

In FIG. 7, the ‘A’ and ‘C’ sections are the stable sections where the fluctuations in signal voltage are not present, and ‘B’ section is the section where a drop in signal voltage occurs. Firstly, while a row enable signal (R_en) is disabled, a reset sampling operation signal (SR) is applied to a switch b (32b) of a CDS (36) during the reset sampling section (A) so that the reset voltage is stored in a capacitor b (33b). After that, upon the application of the row enable (R_en) signal among the signals of FIG. 6 to each unit pixel in a row so that an image data signal is applied to a common junction (31) of a column, then the switch a (32a) of CDS (36) processes data sampling (SD) during C section by the data sampling operation signal applied from outside, stores the resulted value in a capacitor a (33a) and applies a data signal voltage to MUX (35) via a buffer a (34a). Completing the data sampling (SD), reset (RST) signal is applied.

Then, upon the completion of row enabling, a switch b (32b) of CDS (36) for processing the next image process data processes reset sampling (SR) during A section by a reset sampling operation signal applied from outside so as to store the reset voltage to a capacitor b (33b) and to apply a signal to MUX (35) via a buffer b (34b).

Upon running of such series of signals (R_en, SD, RST, SR) for one cycle, image data stored in the unit pixel are obtained, and then the obtained image data are outputted through a sample and hold amplifier (SHA) (37), a programmable gain amplifier (PGA) (38), an analogue-digital converter (ADC) (39) or the like. It means that the image processing data values corresponding to each level are determined by the level of differences in potential of the image stored in each capacitor during the reset sampling section ‘A’ and the data sampling section ‘C’. Therefore, in the case of high illumination, the image processing data value is relatively large, while in the case of low illumination, the image processing data value is relatively small.

However, the image displayed through the image data signals outputted from the processing procedure disclosed in FIGS. 5 to 7 has significant differences from the real image which is directly seen by the human eye. For instance, when strong source of light such as the sun is inputted, errors or differences in the image occur such as false representation where the part around the sun on the screen display is blackened. Most of such distortions or false representations of an image are generally occurred by excessively large data values in the case of high illumination.

There have been techniques for solving the distortion or false representation problems of an image in prior arts as described next. For example, a method has been suggested in which a user directly controls a clamping voltage which is suitable for the outer environment from the outside of the sensor so as to prevent a reset voltage signal from being lowered below the clamping voltage. However, this method is not convenient since the suitable clamping voltage value should be frequently adjusted and determined referring to the distribution of reset voltage signals whenever the outer environment using the image sensor changes, and has problems that a user should frequently control the clamping voltage from outside even in the absence of any changes in the outer environment, since the operational characteristics of each sensor are different according to changes in the fabrication process of an image sensor.

Further, there have been an image sensor with a function of automatically limiting the reset voltage and a method for automatic controlling of the reset voltage of the image sensor, wherein the image sensor by itself can automatically adjust the suitable clamping voltage range according to the changes in the outer environment and the fabrication processes. However, such method still has a problem that further circuits should be constructed for limiting the reset voltage. Accordingly, noise load in a circuit are generated as additional new circuit elements are connected to hundreds or thousands of columns and rows, which makes impossible to follow the current technical trend of high resolution.

### DISCLOSURE OF INVENTION

### Technical Solution

Under such circumstances, the present invention has been designed to solve the problems of the conventional techniques. Therefore, the object of the present invention is to provide an image sensor and an image data processing method, which can display an image just as the real image directly seen by the human eye, even in the case that a strong source of light such as the sun is entered into the picture element part, by, when the image obtained from the picture element part has high illumination, reducing rather large amount of signals relative to the image data obtained from the picture element part, and when the image has lower illumination, allowing the data signals to have values nearly as same as the image data obtained from the picture element part.

Another object of the present invention is to provide an image sensor having a unit pixel is formed by comprising one NMOS and one PMOS light receiving element, wherein the amount of electric current in a source and a drain is relatively large so as to achieve excellent image embodiment even at low illumination, and integration time can be almost removed.

The object of the present invention can be achieved by an image sensor characteristically comprising: a first switch which is operated by a reset sampling signal for sampling reset voltage when a voltage drop in an image data signal occurs, wherein the image data signal is applied from a picture element part; a first capacitor for storing the reset voltage applied from the first switch; a second switch which is operated by a data sampling signal for sampling data voltage after completion of the voltage drop in an image data signal; a second capacitor for storing the data voltage applied from the second switch; and an image data processing circuit equipped with a comparator for comparing the reset voltage with the data voltage.

Further, another object of the present invention is achieved by a method for processing image data of an image sensor characteristically comprising the steps of: upon the application of a row enable signal, outputting an image data signal from a picture element part; storing a sampled reset voltage, upon the application of the reset sampling signal when a voltage drop of said outputted image data signal occurs; storing a sampled data voltage, upon the application of a data sampling signal after completing the voltage drop in the image data signal; and comparing the reset voltage with the data voltage.

It is to be understood that the terms and words used in the specification and claims of the present invention should not be construed to have a limitative meaning provided by conventional definitions or dictionary, but should be understood to have a meaning and a concept corresponding to the technical spirit of the present invention, based on the principle that an inventor may appropriately define the concept and meaning of terms in order to explain the invention to its best.

Accordingly, it is to be understood that both the following embodiments disclosed in the present specification and the constructions disclosed in the attached drawings are merely one of preferred examples of the present invention, and are not be construed to comprehensively represent the technical spirit of the present invention. Therefore, it should be further understood that the various alternatives and modifications which can substitute the present invention at the time of filing the present application may be possible.

### BRIEF DESCRIPTION OF THE DRAWINGS

FIGS. 1 to 2 represent conventional 3-transistor CMOS active pixels.

FIGS. 3 to 4 represent conventional 4-transistor CMOS active pixels.

FIGS. 5 to 7 represent the operation processes of a conventional CMOS image sensor.

FIGS. 8 to 10 represent the operation processes of an image sensor according to the present invention.

FIGS. 11 to 15 represent the detailed operation processes of an image sensor according to the present invention.

FIGS. 16 to 18 represent unit pixels of an image sensor according to the present invention.

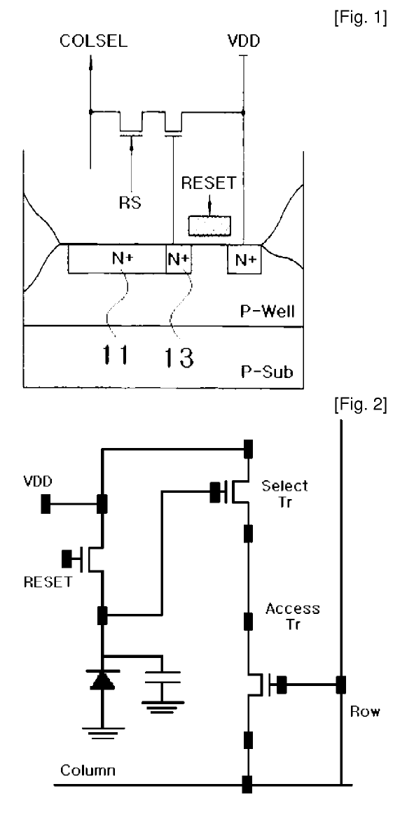

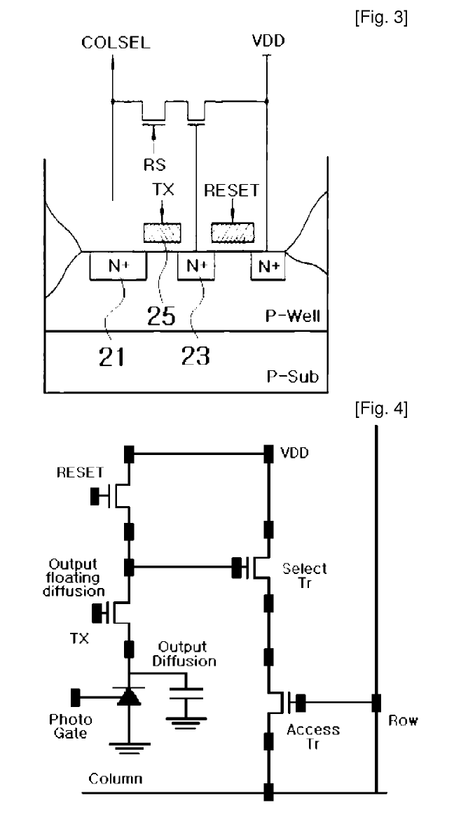

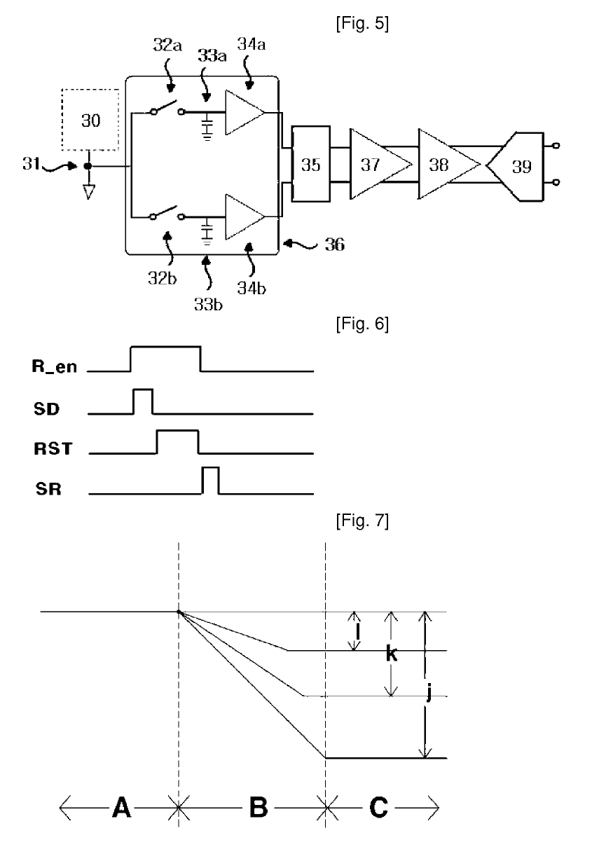

### NUMERALS USED IN MAIN PARTS OF DRAWINGS

40: picture element part
41: common junction of column
42a: first switch
42b: second switch
43a: first capacitor
43b: second capacitor
44a: buffer a
44b: buffer b
45: MUX
46: CDS
47: SHA
48: PGA
49: ADC

### MODE FOR THE INVENTION

Hereinafter, the preferred examples of the present invention are described in detail, with referring to the drawings attached hereto.

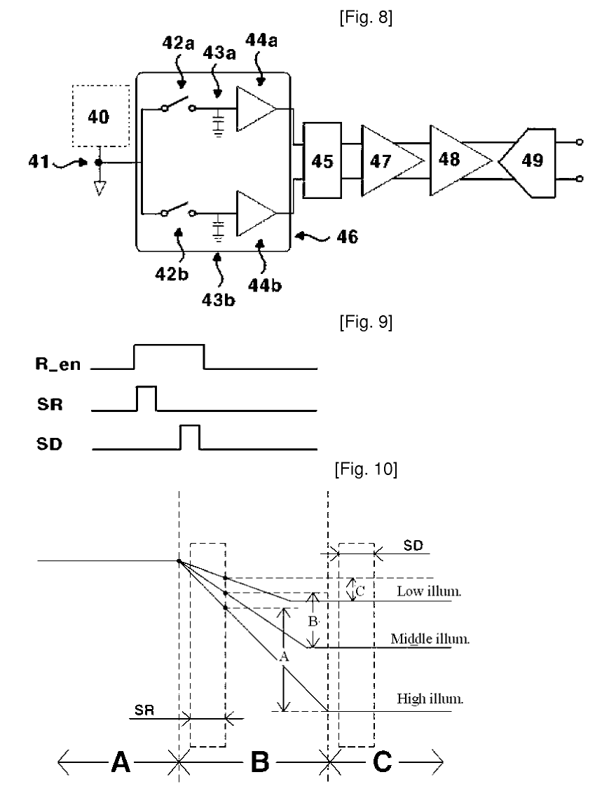

FIG. 8 is a circuit diagram for signal processing, which is connected to the unit pixel (40) of an image sensor according to the present invention. FIG. 9 is a timing diagram of operation signals applied to the circuit diagram for signal processing of an image sensor according to the present invention. FIG. 10 is a waveform diagram of a voltage drop according to the level of brightness of the image signals applied to the unit pixel of an image sensor according to the present invention.

The procedures of the processing disclosed through FIGS. 8 to 10 are now described as follows. Upon the application of a select signal to a row consisting of a large number of unit pixels, the image data signals captured in the large number of unit pixels during the row enable (R_eN) section are applied from the common junction of a column (41) to CDS (Correlated double sampling) (46). The image data signals include many data signals having various levels of illumination depending on the circumstances, ranged from a high illumination signal that is a signal of bright light to a low illumination signal that is a signal of dimmed light.

The data signals according to various levels of illumination reduce the image data voltage applied to a CDS (46)-containing circuit according to each level. Specifically, data signals regarding low illumination reduces the image data voltage relatively small, while data signals regarding high illumination reduces the image data voltage relatively large. FIG. 10 represents the voltage drop in data signals according to the level of illumination. For the sake of convenience in explaining, only three levels are disclosed in FIG. 10, however, in practice, more various levels of data signals may present.

The ‘A’ section and the ‘ C’ section in FIG. 10 are stable sections where signals do not fluctuate, and the ‘B’ section is a section where signal voltage drop occurs. Among the signals disclosed in FIG. 9, the row enable (R_en) signal is applied to each unit pixel of a row, and then an image data signal stored in a unit pixel is applied to the common junction (41) of a column. Then, the first switch (42a) of CDS (46) becomes turned on during the B section, by the reset sampling operation signal applied from the outside, and the reset sampling voltage is stored to a first capacitor (43a). Completing the reset sampling, before completion of row enabling, a second switch (42b) of CDS (46) becomes turned on during the C section, by the data sampling operation signal so as to store the sampled data voltage to a second capacitor (43b) for comparison at a comparator. Upon disablement of the row enable signals, sampling comes to an end.

After the proceeding of one 1H cycle of the series of signals (R_en, SR, SD), the image data stored in unit pixels can be obtained and then outputted through a sample and hold amplifier (SHA) (47), a programmable gain amplifier (PGA) (48) and an analog-digital converter (ADC) (49).

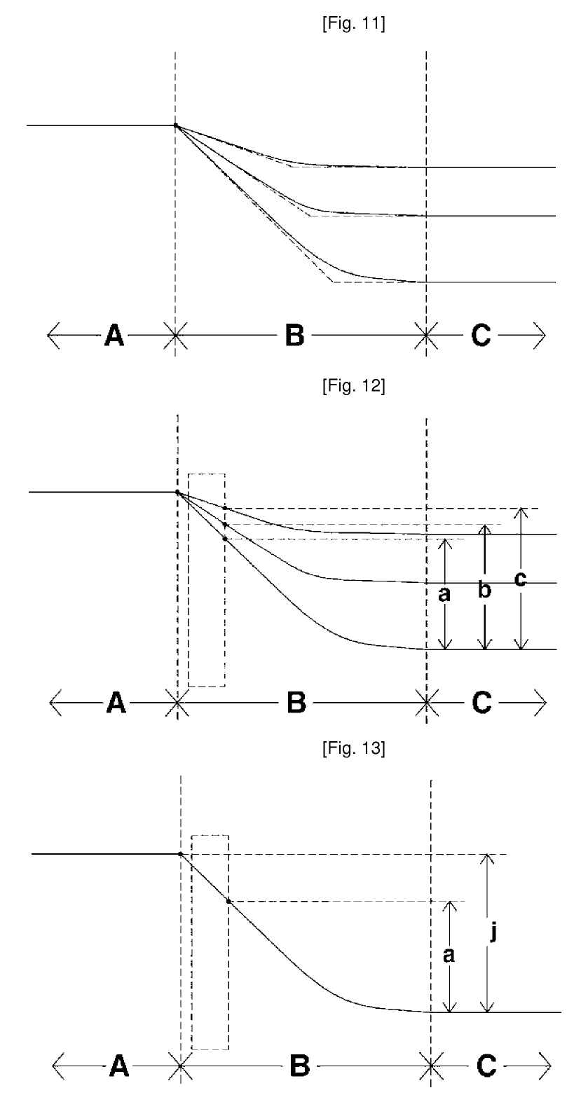

FIGS. 11 to 15 are provided to more specifically explain the operation principle of an image sensor according to the present invention. FIG. 11 schematically illustrates the voltage drop in ‘B’ section of FIG. 10. Since an RC element (τ) is present, owing to parasitic resistance and parasitic capacitance, in complex circuit elements for processing a large number of unit pixels and image data captured in the unit pixels, in the voltage is practically delayed as disclosed in the section ‘B’ of FIG. 11.

FIG. 12 illustrates a reset sampling section and a data sampling section of an image sensor according to the present invention. According to the present invention, the image data acquired to the image sensor is determined by the deferences between a reference voltage being stored during the reset sampling section and a voltage of the image data being stored during the data sampling section. The reference voltages stored to the second capacitor (43b) during the reset sampling section (SR) are a, b and c.

FIG. 13 schematically illustrates the case in which the image sensor according to the present invention is in high illumination condition. When illumination is high, image data acquired to the image sensor is a value as much as ‘a’ which is significantly different from the value ‘j’ of conventional image data.

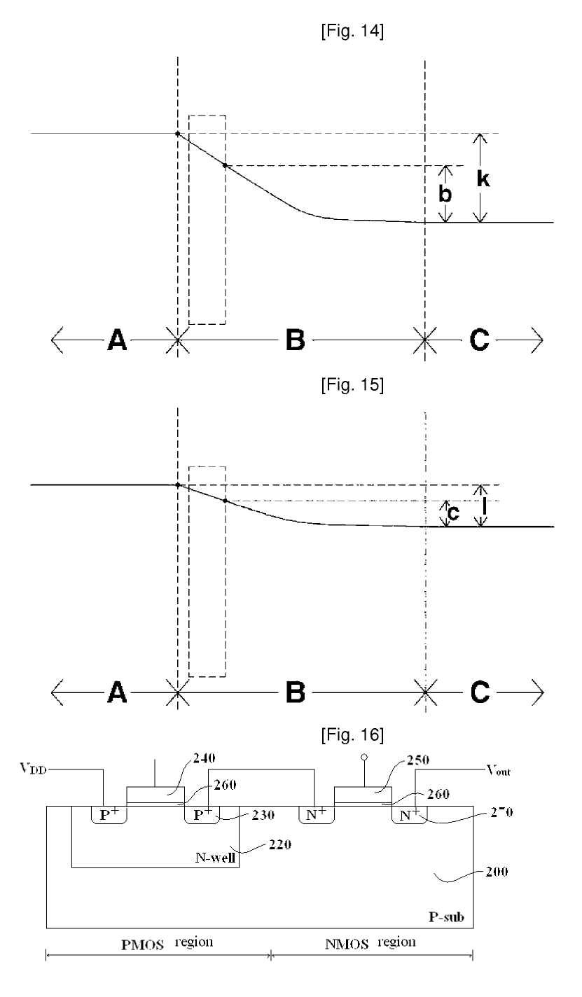

FIG. 14 schematically illustrates the case in which the image sensor according to the present invention is in medium illumination condition. When illumination is medium, image data acquired is a value as much as ‘b’ which is somewhat different from the value ‘k’ of conventional image data.

FIG. 15 schematically illustrates the case in which the image sensor according to the present invention is in low illumination condition. When illumination is low, image data acquired is a value as much as ‘c’ which is slightly different from the value ‘I’ of conventional image data.

As it can be seen from the image data according to the present invention represented by FIGS. 13 to 15, in case of high illumination, relatively large amount of data are reduced as compared to the image data of prior arts, and as the illumination becomes low, the amount of image data value being reduced becomes small so as to provide the image data value just as much as the image data value of prior arts, thereby being capable of reduce big differences in illumination. Accordingly, even if an intensive light source such as the sun is entered through a lens, the processed image becomes similar just as much as the real image directly seen by the human eye. That means it is possible to eliminate the false representation of an image in which an object around the strong light source is represented black.

FIGS. 16 to 18 illustrate the structure of a unit pixel which is formed many on the picture element part (40) of an image sensor according to the present invention. FIG. 16 is a unit pixel structure according to one embodiment of the present invention, which is formed by only using MOS process which is conventionally used in semiconductor fabrication. The unit pixel structure is a 2-transistor structure comprised of 1 PMOS and 1 NMOS wherein the PMOS utilizing a photoelectric conversion mode upon entrance of light, forms a light receiving area, and the NMOS plays a role of a switch by being connected to the PMOS.

By embodying a unit pixel structure comprising 2 transistors unlike the conventional unit pixel structure comprised of one photodiode and 3 transistors, or one photodiode and 4 transistors, the pitch size of the unit pixel can be reduced. Further, since there is no control signal such as conventional reset signals, a metal line in the layout of a pixel can also be reduced. Therefore, the unit pixel structure in the present invention can be simplified.

A method for fabricating a unit pixel according to one embodiment of the present invention is as follows. An N-well (220) is formed in a PMOS area in order to embody a PMOS and an NMOS on a P type semiconductor substrate (200). The process for forming the N-well comprises: forming patterns on a P type semiconductor substrate;

carrying out an ion implantation process of an N type impurity in the state that the region where N-well is to be formed is only open; and then forming the N-well by heat treatment. The gate oxide (260) and polysilicon are sequentially deposited on the front side of the substrate where N-well is formed. The resulted substrate is patterned, and then selectively etched so as to form a floating gate (240) on the PMOS and a select gate (250) on the NMOS, respectively.

Later, a mask which is only open at the source/drain formation region of the PMOS region is formed, and then P type ion implantation at high concentration is carried out so as to form a source/drain (230). Sequentially, a mask which is only open at the source/drain formation region of the NMOS region is formed, and then N type ion implantation at high concentration is carried out so as to form a source/drain (270). Additionally, a Salicide process may be further carried out in order to reduce the resistance on the region of PMOS and NMOS where each source/drain is formed. However, since the PMOS of the present invention is a photoelement which receives light, and thus light should penetrate through a floating gate formed on the upper part of the PMOS, the Salicide process should not be performed on the floating gate.

The principle of a process of a unit pixel according to first embodiment of the present invention is explained as below.

Upon the application of voltage to the source of the PMOS formed on the same substrate where the NMOS is formed, the N-well of the PMOS forms a depletion region which is in electrically neutral state. Later, when photons enter into the N-well that is a depletion region, upon receiving light from the PMOS that is a light receiving part, EHP (electron hole pair) is formed, which derives the formation of a P channel on the lower surface of the gate in the PMOS element. To the select gate formed on the NMOS which is connected to the PMOS, voltage is applied, and then N channel is formed between the source and drain formed on the NMOS so that it can receive the signal charges formed on the PMOS and send out an output signal.

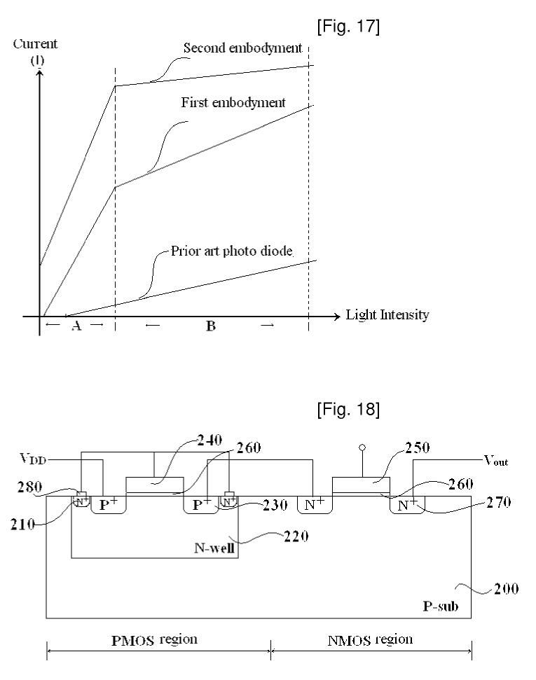

With referring to FIG. 17, in a conventional photodiode, an electric current starts to flow when the intensity of light is over a certain critical point, and the current linearly increases with increase in the intensity of light. However, the pixel of an image sensor comprised of PMOS according to the present invention is a structure where an electric current starts to flow right after the entrance of light, thereby having no dark current. As represented in A region of FIG. 17, it can be seen that the slope of the changes in electric current relative to small changes in light is very rapid and, while the slope of the changes in electric current relative to the changes in light is relatively easy in B region of FIG. 17.

Since the first embodiment of the present invention does not have a control signal such as a conventional reset signal, a metal line in the layout of a pixel can become reduced, making possible to further reduce a pitch size as compared to that of a conventional unit picture element. The PMOS light receiving element of the present invention in which one photon generates an amplified photocurrent, unlike a conventional CMOS image sensor wherein one photon generates one electron-hole pair. Therefore, the current gain of a photocurrent reaches to 100˜1000, and then it is possible to embody an image under low illumination condition where a small amount of light is entered. Further, the present invention makes possible to reduce the charge storage time 100˜1000 times relative to the conventional image sensors such that several tens of clocks of delay become enough for the charge storage time, unlike in conventional image sensors which require 1 frame or 1 line of delay, therefore it makes possible to eliminate integration time and thus to achieve a high speed moving picture.

Additionally, since the unit pixel of a CMOS image sensor according to the present invention is formed by a general MOS process, it eliminates the conventional use of an exclusive process for a CMOS image sensor. According to the present invention, it is possible to receive light from PMOS, with almost no integration time, and to output signals through NMOS, therefore a dark current in the sensor due to long integration, except a dark current caused by a leakage current of MOS for a switch, can be minimized. Accordingly, the present invention does not require a process for growing an epitaxial layer on the surface of a light receiving area for preventing a dark current in conventional CMOS image sensor fabricating process. Further, the present invention does not require a conventional process for forming a micro-lens on the upper part of a unit picture element for collecting light to the light receiving area of a unit picture element, since the PMOS light receiving element of the present invention generates amplified photocurrent per one photon. By eliminating said conventional processes, the present invention can have a cost-saving effect.

The second embodiment of the present invention provides a structure in which the gate of PMOS and the N-well of PMOS are connected to each other.

FIG. 6 is a view illustrating a unit pixel structure of a CMOS image sensor according to second embodiment of the present invention, in which the unit pixel is fabricated by only using MOS process which is used for a conventional semiconductor. The unit pixel structure is a 2-transistor (2T) structure comprised of 1 PMOS and 1 NMOS wherein the PMOS utilizing a photoelectric conversion mode upon light entrance, forms a light receiving area, and the NMOS plays a role of a switch by being connected to the PMOS. A unit pixel in which the gate of said PMOS and N-well are connected is formed.

Therefore, the present invention is capable of simplifying the unit pixel structure by decreasing the pitch size of a unit pixel owing to the embodiment of 2T structure in a unit pixel which conventionally has the structure of 1PD+3T or 1PD+4T, and also reducing the metal line of a pixel layout due to the absence of a control signal such as a conventional reset signal.

FIG. 18 is the unit pixel structure of an image sensor according to the second embodiment of the present invention, and a method for fabricating a unit pixel is described as follows. An N-well (220) is formed in a PMOS area in order to embody PMOS and NMOS on a P type semiconductor substrate (200). The process for forming the N-well comprises: forming patterns on a P type semiconductor substrate; carrying out an ion implantation process of an N type impurity in the state that the region where N-well is to be formed is only open; and then forming the N-well by heat treatment.

The gate oxide (260) and polysilicon are sequentially deposited on the front side of the substrate where N-well is formed. The resulted substrate is patterned, and then selectively etched so as to form a floating gate (240) on the PMOS and a select gate (250) on the NMOS, respectively.

Later, a mask which is only open at the source/drain formation region of the PMOS region is formed, and then P type ion implantation at high concentration is carried out so as to form a source/drain (230). Sequentially, a mask which is only open at the source/drain formation region of the NMOS region is formed, and then N type ion implantation at high concentration is carried out so as to form a source/drain (270).

A contact area (210) is formed on the surface of N-well for connecting the gate (240) formed on the PMOS with N-well (220). To the contact area of the N-well (210), N type ions are implanted with a concentration higher than the concentration of ions used in N-well formation. On the area implanted with N type ions with high concentration, a metal pattern (280) is formed and then PMOS and N-well are electrically connected.

In the second embodiment of the present invention, since the PMOS is a photoelement which receives light, and thus light should penetrate through a floating gate formed on the upper part of the PMOS, Salicide process should not be carried out on the floating gate.

The principle of a process of a unit picture element according to second embodiment of the present invention is explained as below.

Upon the application of voltage to the source of the PMOS formed on the same substrate where the NMOS is formed, the N-well of the PMOS forms a depletion region which is in electrically neutral state. At this time, photons enter into the N-well that is a depletion region, by receiving light from a light receiving part of PMOS so as to form EHP. At this stage, if voltage is applied to the gate, the electrons remained on the N-well which is connected to the gate serve as bias in the substrate, thereby playing a role of lowering a threshold voltage that refers to a minimum voltage required for channel formation. Therefore, P channel is easily formed. Then, voltage is sequentially applied to the select gate formed on the NMOS which is connected to the PMOS, and N channel is formed between the source and the drain formed on the NMOS so that the signal charge formed on the PMOS can be received and then an output signal is sent out.

With referring to FIG. 17, in a conventional photodiode, an electric current starts to flow when the intensity of light is over a certain critical point, and the current linearly increases with increase in the intensity of light. However, in the unit pixel according to second embodiment of the present invention, when voltage is applied to the gate, the electrons remained on the N-well that is connected to the gate, serve as bias in the substrate, thus playing a role of lowering a threshold voltage that refers to the minimum voltage required for channel formation. As represented in A region of FIG. 17, it can be seen that the slope of the changes in electric current relative to small changes in light is very rapid, comparing to the changes appeared in the first embodiment of the present invention. In the meantime, in B region, the slope of the changes in electric current relative to the changes in light is appeared to be relatively easy, comparing to the changes in the first embodiment.

Since the second embodiment of the present invention, as in the first embodiment, does not have a control signal such as a conventional reset signal, a metal line in the layout of a pixel can become reduced, making possible to reduce a pitch size as compared to that of a conventional unit picture element. According to the second embodiment of the present invention, it is possible to embody a clear image with low illumination, since a large amount of electric current can be generated even if a small amount of light is entered to the light receiving area of PMOS. Further, according to the second embodiment of the present invention, it hardly requires integration time, making possible to achieve a high speed moving picture.

According to the second embodiment of the present invention, it is possible to eliminate a conventional process exclusively needed for a CMOS image sensor, by embodying a unit pixel through a MOS process, which is a generally used process, therefore it can be further expected that it would bring about an increase in process yield and decrease in cost for processing.

As it has been described so far, the present invention can simultaneously achieve a technique for fabricating a unit pixel embodying an image at high speed and with high picture quality, as being described referring to FIGS. 16 to 18, as well as a technique for embodying a wide dynamic range through which an image can be embodied just like the real image directly seen by the human eye, even in the case that a strong source of light such as the sun is entered into the unit pixel, by, when the image obtained from the picture element part has high illumination, reducing rather large amount of signals relative to the image data obtained from the picture element part, and as the illumination being lowered, allowing the data signals to have values nearly as same as the image data obtained from the picture element part, as being described referring to FIGS. 8 to 15.

The present invention as being described so far has been illustrated by the preferred embodiments of the present invention; however it is not limited to the foregoing examples. Many alternatives, modifications, and variations which would be apparent to those skilled in the art, can be made to the present invention without departing from the scope of the present invention.

### INDUSTRIAL APPLICABILITY

Therefore, the image sensor and the image data processing method thereof according to the present invention makes possible to reduce a significant amount of image data relative to that obtained from the unit pixel in the case of an image with high illumination, and to reduce less amount of image data as the illumination of image data obtained from the unit pixel is lowered, allowing the image data to have nearly the same value as the image data obtained from the unit pixel at lower illumination. Therefore, the wide dynamic range in the processed image can be achieved, wherein the wide dynamic range allows the displayed image to be just like the real image directly seen by the human eye even in the case that an intensive light source such as the sun is entered through the unit pixel.

Further, since the unit pixel in the image sensor of the present invention is formed with one NMOS and one PMOS light receiving element, the pitch size of the pixel itself can be reduced.

Still further, since the amount of the electric current flowing through the source and the drain is large even if a small amount of light is entered into the light receiving element, the image sensor of the present invention has excellent image embodying characteristics even at lower illumination.

Additionally, in the image sensor of the present invention, conventional integration time is not necessary, thereby being possible to embody an image with high quality at high speed.

1. An image sensor comprising: a first switch which is operated by a reset sampling signal for sampling reset voltage when a voltage drop in an image data signal occurs, wherein the image data signal is applied from a picture element part; a first capacitor for storing the reset voltage applied from the first switch; a second switch which is operated by a data sampling signal for sampling data voltage after completion of the voltage drop in an image data signal; a second capacitor for storing the data voltage applied from the second switch; and an image data processing circuit equipped with a comparator for comparing the reset voltage with the data voltage.

2. The image sensor according to claim 1, wherein the picture element part is formed by the combination of unit pixels comprising one NMOS and one PMOS light receiving element.

3. The image sensor according to claim 1, wherein the reset sampling signal and the data sampling signal are enabled during one row enable signal section applied to the picture element part.

4. A method for processing image data of an image sensor comprising the steps of: upon the application of a row enable signal, outputting an image data signal from a picture element part; storing a sampled reset voltage, upon the application of the reset sampling signal when a voltage drop in said outputted image data signal occurs; storing a sampled data voltage, upon the application of a data sampling signal after completing the voltage drop in the image data signal; and comparing the reset voltage with the data voltage.

5. The method for processing image data of an image sensor according to claim 4, wherein the reset sampling signal and the data sampling signal are enabled during one row enable signal section applied to the picture element part.
